(19) United States
(12) Patent Application Publication
(10) Pub. No.: US 2024/0426027 A1
(43) Pub. Date: Dec. 26, 2024

(54) METHOD FOR PREPARING A CELLULOSE DOPE

(71) Applicant: INDUO, TOURCOING (FR)

(72) Inventors: Sébastien FRANCOIS, LONDON (GB); Marjorie SAISON, LONDON (GB)

(73) Assignee: INDUO, TOURCOING (FR)

(21) Appl. No.: 18/701,350

(22) PCT Filed: Oct. 12, 2022
(86) PCT No.: PCT/FR2022/051918

§ 371 Date: Apr. 15, 2024

(30) Foreign Application Priority Data
Oct. 15, 2021 (FR) 2110951

(51) Int. Cl. D01D 1/02; B09B 3/35; B09B 3/80; B09B 101/85; C08B 1/00; C08J 11/16; C08L 1/02

(52) U.S. Cl. CPC D01D 1/02; B09B 3/35; B09B 3/80; C08B 1/003; C08J 11/16; C08L 1/02; B09B 2101/85; C08J 2301/02; C08L 2207/20; D10B 2201/22

(57) ABSTRACT

A method for preparing cellulose dope from textile waste including cellulose fibers in a mass percentage of more than 50%. The method includes shredding the textile waste in order to obtain a first mixture of shredded fibers and residues, separating at least a portion of the non-cellulosic components from the first mixture in order to obtain a second mixture in which the mass percentage of cellulose fibers is greater than the mass percentage of cellulose fibers in the first mixture, filtering the second mixture in order to recover a solid phase including the cellulose fibers, dissolving the cellulose fibers of the solid phase so as to obtain a cellulose dope including undissolved particles, and filtering the cellulose dope in order to obtain a cellulose dope that is separated from the undissolved particles.

### TECHNICAL FIELD

This disclosure relates to the field of preparing dissolved cellulose dope, in particular cellulose dope made from textile waste.

### PRIOR ART

Around the world, millions of tons of textile waste fibers are produced annually. For example, it is estimated that 85% of purchased clothing is thrown away within a year of purchase. A large portion of this textile waste includes textile waste based on a mixture of cotton fibers and synthetic fibers which are primarily polyester fibers. In the clothing industry, cotton-based clothing represents 35% of the market for example.

Cotton fibers are composed of cellulose, a naturally occurring polymer found in many plant species. Cellulose represents 35 to 50% of plant biomass, thus making cellulose the most abundant compound in plant biomass. It is found in an almost pure state in the hairs of cotton seeds, in the form of fibers. These cotton fibers are harvested from cotton plants and consist of long intertwined chains of cellulose polymers. These fibers are spun, dyed, and finally woven, knitted and assembled into textiles. Natural fibers, particularly cotton-based fibers, are generally raw materials of variable costs due to weather variations and the political and socioeconomic instabilities of the main production regions.

Cotton cultivation is a crop with high consumption of resources and energy. For example, it is estimated that around 3000 liters of water are needed to produce around 500 grams of cotton fiber. In addition, cultivation of this plant requires the use of a large amount of pesticides and a large cultivation area, and produces a significant amount of greenhouse gases. Given the increasing demand for agricultural land, decreasing access to water, and an expanding world population and therefore a growing demand for cotton, the cost of cotton production is increasing. Thus, cotton production appears to be unsustainable and it is conceivable that cotton will become unprofitable in the future.

There is therefore a need to find ways to reuse cotton from textile waste that contains it. However, textiles comprising cotton are mainly in the form of a mixture of cotton fibers and synthetic fibers. Therefore, in order to reuse cotton it is necessary to separate it from the synthetic fibers and the chemicals potentially present in the textile. These textiles, however, have the disadvantage of being difficult to recycle due to their composition and the performance of the recycling methods. Textiles based on cotton fibers and synthetic fibers are therefore usually sold as second-hand goods or are torn up for reuse as low-quality textiles.

However, some recent recycling methods for textiles based on cotton fibers and synthetic fibers present better results. They work by dissolving the cellulose of the cotton in order to isolate it from the synthetic fibers. A major disadvantage of this method is that the cellulose obtained is of low quality. Indeed, a large amount of impurities, such as the chemicals or synthetic fibers present in textile waste, are found in the dissolved cellulose solution and degrade the quality of the regenerated cellulose fiber.

There is therefore a need to provide a method for recycling textiles comprising cotton fibers and synthetic fibers among other materials and making it possible to produce a better quality of cellulose dope.

### SUMMARY

This disclosure improves the situation.

A method is proposed for preparing cellulose dope from textile waste comprising cellulose fibers in a mass percentage greater than 50%, the method comprising the following steps:
S1 shredding the textile waste in order to obtain a first mixture of shredded fibers and residues,
S2 separating at least a portion of the non-cellulosic components from the first mixture in order to obtain a second mixture in which the mass percentage of cellulose fibers is greater than the mass percentage of cellulose fibers in the first mixture,
S3 filtering the second mixture in order to recover a solid phase comprising the cellulose fibers,
S4 dissolving the cellulose fibers of the solid phase so as to obtain a cellulose dope comprising undissolved particles, and
S5 filtering the cellulose dope in order to obtain a cellulose dope that is separated from the undissolved particles.

The method according to this invention makes it possible to obtain a high quality of cellulose dope from textile waste comprising a large portion of non-cellulosic fibers; this allows using a wider variety of textiles for recycling. The separation and filtration steps make it possible to obtain this quality of cellulose dope, due to elimination of the non-cellulosic fibers.

Other optional and non-limiting features are as follows.

The textile waste may comprise cellulose fibers in a mass percentage of less than 85%, or even less than 80%.

The textile waste may comprise cellulose fibers, polyester fibers, and other types of synthetic fibers.

The method may further comprise a step S0 of preparing the textile waste by removing hard points such as buttons and zippers (“smoothing” hereinafter) prior to or simultaneous with step S1.

Step S1 is carried out by means of a shredding device such as a knife shredder or a ball mill.

Step S2 may be a step of chemically separating a portion of the non-cellulosic components from the first mixture. Step S2 may be carried out by dissolving a portion of the non-cellulosic components of the first mixture. Dissolution of a portion of the non-cellulosic components of the first mixture may be carried out by placing the first mixture in contact with an alkaline aqueous solution. The aqueous alkaline solution may be an aqueous alkaline solution comprising hydroxide ions. The alkaline aqueous solution may comprise sodium hydroxide, calcium hydroxide, or potassium hydroxide. The aqueous alkaline solution may be an aqueous alkaline solution based on sodium hydroxide, the mass percentage of sodium hydroxide able to be between 3 and 25%, in particular between 5 and 15%, preferably between 6 and 10%, more particularly 8%. Step S2 may be carried out at a temperature between 50 and 150° C., preferably between 70 and 100° C. More particularly, step S2 may be carried out, in certain cases, at a temperature between 70 and 90° C., or, in certain other cases, at a temperature between 80° C. and 100° C. Step S2 may be carried out for a time interval of between 40 and 240 minutes, preferably between 40 and 90 minutes, more particularly for 90 minutes. In certain cases, step S2 may be carried out for a time interval of between 15 and 240 minutes, preferably between 20 and 60 minutes, more particularly for 30 minutes. The alkaline aqueous solution may further comprise a phase transfer catalyst. The phase transfer catalyst may be a quaternary ammonium, such as benzyltributylammonium chloride, methyltrioctylammonium bromide, or mixtures thereof, in particular benzyltributylammonium chloride. The mass percentage of phase transfer catalyst may be between 0.1 and 2%, in particular between 0.5% and 2%. More particularly, the mass percentage of transfer catalyst may be 0.7% in certain cases, or, in certain other cases, between 1 and 2%, preferably between 1.25 and 1.75%, more particularly may be 1.61%.

The method may further comprise a step S2′ of decolorization of the textile waste; the decolorization step may be before step S2 or after step S3.

The method may further comprise a second shredding step S1′ in which the second mixture is shredded; the second shredding step may be after step S3.

The solid phase comprising the cellulose fibers obtained at the end of step S3 may comprise a mass percentage of material other than shredded cellulose fibers, of less than 8%, preferably less than 5%, more particularly less than 2%.

Step S5 may be carried out using a filter comprising pores of a size between 5 and 100 μm. In particular, the size of the pores in certain cases may be between 10 and 50 μm, more particularly may be 19 μm, or, in certain other cases, may be between 6 and 60 μm, more particularly may be 6 μm.

Step S4 may comprise:
a step S4-11 of placing the solid phase comprising the cellulose fibers in contact with an alkaline aqueous solution comprising sodium hydroxide in order to obtain a solid phase of alkaline cellulose fibers,
a step S4-12 of pressing the solid phase of alkaline cellulose fibers in order to eliminate the excess alkaline solution and obtain a compact solid phase of alkaline cellulose fibers,
a step S4-13 of grinding the solid phase of alkaline cellulose fibers obtained at the end of step S4-12, in order to obtain a solid phase of alkaline cellulose fibers that is less compact than the solid phase obtained at the end of step S4-12,
a step S4-14 of aging the solid phase comprising the alkaline cellulose fibers obtained at the end of step S4-13,
a step S4-15 of placing the solid phase of aged alkaline cellulose fibers in contact with carbon disulfide in order to obtain a solid phase of cellulose xanthate fibers,
a step S4-16 of placing the solid phase of cellulose xanthate fibers in contact with an alkaline aqueous solution comprising sodium hydroxide in order to obtain a cellulose dope comprising undissolved particles, and
a step S4-17 of maturing the cellulose dope comprising undissolved particles. The method may further comprise a spinning step S6, the spinning step being implemented by wet spinning.

The shredded fibers and residues of the first mixture or the cellulose fibers of the solid phase comprising the cellulose fibers may have a size of less than 1 mm. Step S4 may comprise:
a step S4-21 of placing the solid phase comprising the cellulose fibers in contact with an aqueous solution comprising N-methylmorpholine N-oxide (NMMO),
a step S4-22 of evaporating the water contained in the aqueous solution comprising (NMMO) and the solid phase comprising the cellulose fibers.

The method may further comprise a spinning step S6, the spinning step being implemented by dry-jet wet spinning.

The cellulose dope obtained at the end of step S5 may have a viscosity greater than or equal to 2 Pa·s.

### BRIEF DESCRIPTION OF DRAWINGS

Other features, details, and advantages will become apparent upon reading the detailed description below, and upon analyzing the appended drawings, in which:

FIG. 1 schematically shows a diagram describing the steps of the method according to this invention for the conversion of textile waste into a cellulose dope.

FIG. 2 shows a ternary plot in which the axes respectively represent the mass percentage of water, the mass percentage of cellulose, and the mass percentage of NMMO, as well as the evolution of these proportions during implementation of the lyocell process.

### DEFINITIONS

In this invention, cellulose dope is a state-of-the-art material known to those skilled in the art. It is typically a viscous solution comprising cellulose molecules or molecules derived from cellulose which are dissolved in a solvent, and which is devoid of cellulose fibers. It is therefore possible for those skilled in the art to understand unambiguously what the term “cellulose dope” refers to. In particular, those skilled in the art know that “dissolving pulp”, described for example in WO 2021/181007, is not a “cellulose dope”. In fact, “dissolving pulp” is a material that does not flow and comprises interwoven cellulose fibers.

Textile waste includes any type of textile from two main sources: new textile waste and production scraps from the textile industry, and used textiles from households or businesses. These textiles can be any type of textile, for example clothing, household linen, or rags. Textile waste as understood in this invention generally comprises non-filamentous components, for example coloring pigments, and non-fibrous components, for example buttons or labels.

### DESCRIPTION OF EMBODIMENTS

This invention relates to a method for preparing cellulose dope from textile waste comprising cellulose fibers in a mass percentage greater than 50%, the method comprising the following steps:
S1 shredding the textile waste in order to obtain a first mixture of shredded fibers and residues,
S2 separating at least a portion of the non-cellulosic components from the first mixture in order to obtain a second mixture in which the mass percentage of cellulose fibers is greater than the mass percentage of cellulose fibers in the first mixture,
S3 filtering the second mixture in order to recover a solid phase comprising the cellulose fibers,
S4 dissolving the cellulose fibers of the solid phase so as to obtain a cellulose dope comprising undissolved particles, and
S5 filtering the cellulose dope in order to obtain a cellulose dope that is separated from the undissolved particles.

Textile waste is thus characterized by a mass percentage of cellulose fibers that can vary within a wide range. The method according to this invention thus has the advantage of being applicable to a large number of textile wastes in which the overall mass percentage of cellulose fibers is within the range mentioned above. This thus makes it possible to avoid sorting prior to the method, which is required in prior methods in order to collect only the textile waste comprising a very high mass percentage of cellulose fibers.

The textile waste according to this invention may comprise cellulose fibers in a mass percentage of less than 85%, or even less than 80%.

In general, the cellulose fibers mainly come from cotton used in textile manufacturing. The fibers may come from other materials, such as viscose or lyocell.

The textile waste may comprise cellulose fibers, polyester fibers, and other types of synthetic fibers. The textile waste may also comprise non-fibrous parts (buttons, fastenings, decorative elements for example).

Polyester is a family of polymers whose chain repeat units contain the ester function (—C(O)—O—). It is generally mixed with cellulose fibers to improve the quality of the textile. Indeed, textiles based on cellulose fibers and polyester fibers have the advantages of both types of fibers while reducing their respective disadvantages. Examples of the most commonly used polyesters are semi-aromatic copolyesters such as polyethylene terephthalate (PET), and copolymers of terephthalic acid and ethylene glycol. A person skilled in the art will be able to determine what polymers belong to the polyester family.

Synthetic fibers other than polyester fibers are fibers produced from synthetic materials. These synthetic materials are almost exclusively products obtained from hydrocarbons. Synthetic fibers other than polyester fibers may in particular be polyamide fibers, chlorofibers, acrylic fibers, vinyl fibers, elastane, aramid fibers, or polyethylene fibers.

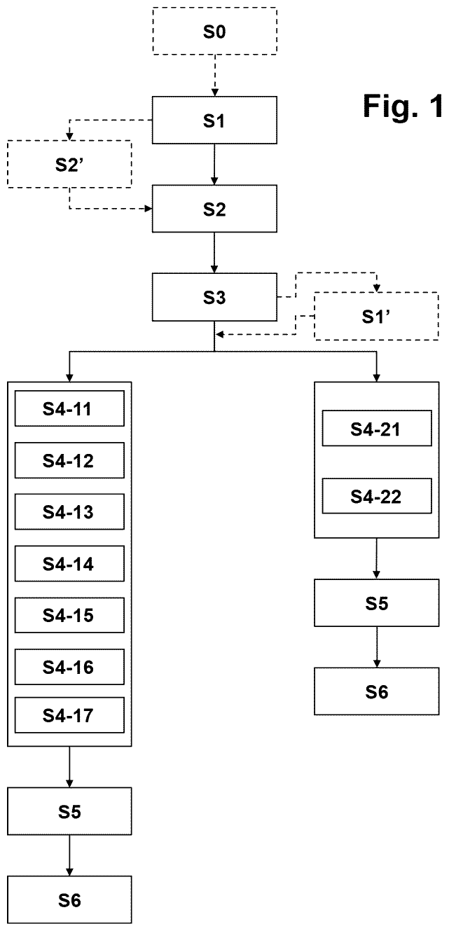

Reference is now made to FIG. 1. FIG. 1 schematically shows a diagram describing the steps of the method for preparing a cellulose dope from textile waste according to this invention. The steps, including optional steps, will be described in the order of completion.

The method for preparing cellulose dope may further comprise a step S0 of smoothing textile waste prior to or simultaneous with step S1.

The smoothing step consists in particular of removing seams and hard points, for example buttons or zippers, from textile waste. This step has the advantage of removing non-filamentous components from textile waste. This smoothing step may be carried out by hand or automatically using a hard point extraction device.

According to one embodiment, smoothing step S0 is carried out using a tearing machine such as a Laroche Cadette or Laroche Exel type of machine.

### Shredding Step S1

According to the invention, shredding step S1 comprises the shredding of the textile waste in order to obtain a first mixture of shredded fibers and residues.

Shredding step S1 makes it possible in particular to shred the textile waste into powder and/or filaments. It appears that the preliminary shredding of textile waste ultimately improves the quality of the cellulose dope. After step S1, a first mixture of shredded fibers and residues is collected, in the form of powder and/or filaments.

Step S1 may be carried out using a shredding device such as a knife shredder or a ball mill.

Such devices are particularly suitable for shredding fibrous materials such as textile waste. These two types of devices allow very good control of the fineness of the shredded material.

The first mixture of shredded fibers and residues may also be washed, for example with water.

### Separation Step S2

According to the invention, separation step S2 comprises the separating of at least a portion of the non-cellulosic components from the first mixture in order to obtain a second mixture in which the mass percentage of cellulose fibers is greater than the mass percentage of cellulose fibers in the first mixture.

This step thus makes it possible to collect a second mixture in which the proportion of non-cellulosic fibers is reduced. This step has the advantage of partially separating the cellulose fibers from the other components in the textile waste. The fibers which will be subjected to treatment enabling the preparation of cellulose dope are thus more concentrated in cellulose, therefore leading to preparation of a better quality of cellulose dope.

Step S2 may be a step of chemically separating a portion of the non-cellulosic components from the first mixture.

“Step of chemical separation” is understood to mean a separation step which uses a chemical separation mechanism in which an element is separated by converting it into one or more other elements, generally with a state change. Chemical separation offers the advantage of being more efficient and less damaging to the cellulose fibers than mechanical separation. Indeed, a mechanical separation step is poorly suited for textile waste where the cellulose fibers and synthetic fibers are closely mixed, particularly when they are spun or woven together. Thus, a chemical separation step makes it possible to selectively separate one element of the textile waste from the other elements by means of the different chemical properties of the different elements.

According to one embodiment, step S2 is carried out by dissolving a portion of the non-cellulosic components of the first mixture.

This dissolution step makes it possible in particular to produce a second mixture comprising a solid phase composed of cellulose fibers and undissolved non-cellulosic fibers, and a liquid phase comprising dissolved non-cellulosic fibers. Dissolution of a portion of the non-cellulosic components allows in particular a more efficient separation, because the dissolved non-cellulosic components are in a different phase from that of the cellulose fibers.

According to one embodiment, the dissolution of a portion of the non-cellulosic components of the first mixture is carried out by placing the first mixture in contact with an alkaline aqueous solution.

An alkaline aqueous solution allows in particular the extraction of polyester fibers from the first mixture. Indeed, contact of the fibers with the aqueous alkaline solution has the effect of dissolving the polyester and depolymerizing it. In particular, PET depolymerizes under the action of an aqueous alkaline solution, to produce its constituent monomers: terephthalic acid and ethylene glycol. The action of the aqueous alkaline solution on the first mixture makes it possible to produce a liquid phase composed of the aqueous alkaline solution, terephthalic acid, and ethylene glycol, and a solid phase composed of cellulose fibers and undissolved non-cellulosic fibers. Generally, at the end of this step, a mass percentage of 90 to 100% of the amount of polyester is removed, preferably 100%.

The alkaline aqueous solution may be an alkaline aqueous solution comprising hydroxide ions.

In such case, the alkaline aqueous solution may comprise sodium hydroxide, calcium hydroxide, or potassium hydroxide.

Sodium hydroxide, calcium hydroxide, and potassium hydroxide are strong bases. They thus make it possible to dissolve almost all, if not all, of the polyester, in particular PET. Thus, the solid phase composed of cellulose fibers and undissolved non-cellulosic fibers is free of polyester, in particular of PET.

The molar concentration of strong bases in the aqueous solution may be between 1.25 and 3.75 mol/L, preferably between 1.5 and 2.5 mol/L, more particularly 2 mol/L in certain cases, or 2.5 mol/L in certain other cases.

The aqueous alkaline solution may be an aqueous alkaline solution based on sodium hydroxide. The mass percentage of sodium hydroxide may be between 5 and 15%, preferably between 6 and 10%, more particularly 8% in certain cases, or 10% in certain other cases.

The amount of alkaline aqueous solution will be chosen according to the amount of shredded fibers and residues. The greater the amount of shredded fibers and residues, the greater the amount of alkaline aqueous solution will be. The mass percentage of base in the aqueous alkaline solution is preferably chosen in such a manner that the base is in excess relative to the mass of PET in the first mixture.

Step S2 may be carried out at a temperature between 50 and 150° C., preferably between 70 and 100° C. More particularly, step S2 may be carried out, in certain cases, at a temperature between 70 and 90° C., or, in certain other cases, at a temperature between 80° C. and 100° C.

The heating in step S2 may be carried out by means of reflux heating.

Step S2 may be carried out during a time interval of between 40 and 240 minutes, preferably 40 and 90 minutes, more particularly for 90 minutes.

In certain cases, step S2 may be carried out during a time interval of between 15 and 240 minutes, preferably between 20 and 60 minutes, more particularly for 30 minutes.

The duration of step S2 will be chosen so as to dissolve almost all, if not all, of the polyester fibers, in particular PET. If the duration is too short, it is possible that a significant portion of polyester will remain in solid form.

The alkaline aqueous solution may further comprise a phase transfer catalyst.

The use of a phase transfer catalyst makes it possible to accelerate the reaction. In particular, it allows accelerating chemical reactions which transform a chemical species from one initial phase to another phase, for example from a solid phase to a liquid phase. The main phase transfer catalysts are salts of phosphonium or of quaternary ammonium. The addition of a phase transfer catalyst makes it possible to improve yields but also to reduce the degradation of cotton by the base contained in the alkaline aqueous solution.

The phase transfer catalyst may be a quaternary ammonium, in particular benzyltributylammonium chloride (BTBAC), trioctylmethylammonium bromide (TOMAB), or mixtures thereof, in particular BTBAC.

The molar concentration of the phase transfer catalyst in the alkaline aqueous solution may be between 0.005 and 0.13 mol/L. In particular, this molar concentration may be, in certain cases, between 0.04 and 0.08 mol/L, preferably between 0.05 and 0.075 mol/L, more particularly may be 0.07 mol/L, or, in certain other cases, may be between 0.025 and 0.07 mol/L, more particularly may be 0.025 mol/L.

For example, when the catalyst is BTBAC, the mass percentage of phase transfer catalyst in the alkaline aqueous solution may be between 0.1 and 2%, in particular between 0.5% and 2%. More particularly, the mass percentage of BTBAC may be 0.7% in certain cases, or, in certain other cases, may be between 1 and 2%, preferably between 1.25 and 1.75%, more particularly may be 1.61%.

The method for preparing cellulose dope according to this invention may further comprise a step S2′ of decolorization of the textile waste; the decolorization step may be before or after separation step S2.

The decolorization step makes it possible to decolorize the textile waste, i.e. to remove or deactivate the non-filamentous components used to color textiles, such as coloring pigments. The decolorization step thus makes it possible to adjust the whiteness of the fibers of the first mixture or second mixture by removal or degradation of the coloring agents.

Step S2′ may be achieved by means of decolorization via oxidation, decolorization via reduction, via acid or base treatment, or via enzymatic decolorization, preferably decolorization via oxidation, via reduction, or via acid or base treatment.

Step S2′ may be carried out in two steps, three steps, four steps, or five steps.

The steps of step S2′ may be selected among an acid treatment, a sodium hydroxide treatment, a hydrogen peroxide treatment, an ozone treatment, and a sodium dithionite treatment.

The method for preparing cellulose dope according to this invention may further comprise a second shredding step S1′ in which the second mixture is shredded; the second shredding step may be after step S3.

This second shredding step in which the second mixture is shredded makes it possible to adjust the shred fineness of the solid phase in particular so that dissolution step S4 is easier to carry out. This step is carried out after filtration step S3. In the case where the method comprises a decolorization step S2′ subsequent to step S2, shredding step S1′ is preferably carried out after decolorization step S2′.

Step S1′ may be carried out by means of a shredding device such as a knife shredder or a ball mill.

### Filtration Step S3

According to the invention, filtration step S3 comprises filtration of the second mixture in order to recover a solid phase comprising cellulose fibers and other materials.

Filtration step S3 makes it possible to separate the solid phase from the liquid phase of the second mixture in order to recover the solid phase which is more concentrated in cellulose fibers.

Step S3 may be carried out by means of a filter comprising pores smaller than the shred fineness achieved in step S1 or S1′.

Preferably, the solid phase comprising the cellulose fibers obtained at the end of step S3 comprises a mass percentage of materials other than cellulose fibers of less than 8%, preferably less than 5%, more particularly less than 2%.

These materials other than cellulose fibers may in particular be polyamide, elastane, wool, or silk. These materials are not dissolved in step S2 and therefore remain in the solid phase. The mass percentage of materials other than cellulose fibers is therefore very low, thus making it possible to prepare a better quality of cellulose dope comprising few impurities.

The solid phase comprising the cellulose fibers may also be washed, for example with an aqueous solution of acetic acid. It may then be filtered and then washed, for example with distilled water. It may then be filtered and then dried.

### Dissolution Step S4

According to the invention, dissolution step S4 comprises the dissolution of the cellulose fibers of the solid phase so as to obtain a cellulose dope comprising undissolved particles.

Dissolution step S4 makes it possible to dissolve the cellulose fibers in order to recover cellulose dope. Cellulose dope comprises undissolved particles, such as the impurities mentioned above which were not reacted with during the dissolution step, and dissolved particles. The undissolved impurities are small but still need to be removed from the cellulose dope.

The dissolution step may be carried out in two ways, according to two processes known to those skilled in the art: the “viscose” process which will be described first and the “lyocell” process which will be described second.

### Dissolution Step S4 According to the Viscose Process

According to the viscose process, step S4 comprises:
a step S4-11 of placing the solid phase comprising the cellulose fibers in contact with an alkaline aqueous solution comprising sodium hydroxide in order to obtain a solid phase of alkaline cellulose fibers, called mercerization,
a step S4-12 of pressing the solid phase of alkaline cellulose fibers in order to eliminate the excess alkaline solution and obtain a compact solid phase of alkaline cellulose fibers, in which the mass percentage of cellulose is 20 to 40%, preferably 25% to 35%, more particularly about 30%,
a step S4-13 of grinding the solid phase of alkaline cellulose fibers obtained at the end of step S4-12, in order to obtain a solid phase of alkaline cellulose fibers that is less compact, i.e. for which the density is between 80 and 180 g/L, than the solid phase obtained at the end of step S4-12,
a step S4-14 of aging the solid phase comprising the alkaline cellulose fibers obtained at the end of step S4-13,
a step S4-15 of placing the solid phase of aged alkaline cellulose fibers in contact with carbon disulfide in order to obtain a solid phase of cellulose xanthate fibers,
a step S4-16 of placing the solid phase of cellulose xanthate fibers in contact with an alkaline aqueous solution comprising sodium hydroxide in order to obtain a cellulose dope comprising undissolved particles, and
a step S4-17 of maturing the cellulose dope comprising undissolved particles.

Step S4-11 allows the cellulose fibers of the solid phase to react with an alkaline aqueous solution. Preferably, the base contained in the alkaline aqueous solution is strong. This step allows impregnating the cellulose fibers with the base contained in the alkaline aqueous solution in order to form alkaline cellulose fibers which are swollen in comparison to the cellulose fibers alone.

The mass of sodium hydroxide may be chosen in such a manner that there is excess sodium hydroxide relative to the mass of the solid phase comprising the cellulose fibers, which ensures maximum swelling of the cellulose fibers. The aqueous alkaline solution of step S4-11 may be an aqueous alkaline solution based on sodium hydroxide with a mass percentage of sodium hydroxide that is between 15 and 25%.

Step S4-11 may be carried out during a time interval of between 20 and 60 min at a temperature of between 30 and 50 C.

The solution is pressed in step S4-12 in order to eliminate the excess sodium hydroxide and is ground in step S4-13. The alkaline cellulose fibers are then aged under an oxygen atmosphere in step S4-14, for example for 3 h40 min, or in some cases for 15 h30 min.

In step S4-15, the alkaline cellulose fibers are treated by placing them in contact with carbon disulfide in order to form cellulose xanthate fibers.

The mass of carbon disulfide can impact the dissolution of cellulose fibers. It is preferable that it be at least equal to 30% of the initial mass of the solid phase comprising the cellulose fibers. The mass ratio of carbon disulfide to alkaline cellulose fibers is preferably between 0.2 and 0.5.

The duration of step S4-15 has an impact on the conversion of cellulose xanthate fibers. It is therefore selected so that there is significant conversion of cellulose fibers into cellulose xanthate fibers. The gamma number of the cellulose xanthate fibers is between 25 and 50%, preferably between 30 and 45%. Temperature also has an impact on the conversion of alkaline cellulose fibers into cellulose xanthate fibers. The temperature is selected such that carbon disulfide is present in gaseous form during step S4-15. Thus, step S4-15 may be carried out during a time interval of between 100 and 200 min at a temperature of between 25 and 50° C., in particular between 25 and 35° C. These operating conditions are suitable for carrying out step S4-15 under vacuum.

Step S4-16 allows dissolving the cellulose xanthate fibers by placing them in contact with an alkaline aqueous solution. Cellulose xanthate is then present in the form of a viscous paste, called cellulose dope. This cellulose dope also contains dissolved and undissolved impurities as mentioned above.

According to one embodiment, the aqueous alkaline solution of step S4-16 is an aqueous alkaline solution based on sodium hydroxide with a mass percentage of sodium hydroxide of between 2 and 15%, in particular between 5 and 15%.

The dissolution of cellulose xanthate fibers is achieved by placing the cellulose xanthate in contact with a base and mixing. Those skilled in the art will know how to adjust the concentration of base in order to obtain a cellulose dope comprising a mass percentage of cellulose of between 5 and 12% and a mass percentage of base of between 2 and 8%, in particular between 4 and 6%. Preferably, the chosen base is sodium hydroxide.

According to one embodiment, step S4-16 is carried out during a time interval of between 150 and 200 min at a temperature of between 0 and 10° C.

In step S4-17, the cellulose dope is left to rest after step S4-16, for example for 16 h.

### Dissolution Step S4 According to the Lyocell Process

In the case where dissolution step S4 is carried out according to the lyocell process, it is necessary that, during shredding step S1 or after shredding step S1′ if such is implemented, the waste textiles are shredded in such a way that the first mixture of shredded fibers and residues or the fibers of the second mixture when shredding step S1′ is carried out have a size of less than 1 mm.

In such a case, step S4 comprises:
a step S4-21 of placing the solid phase comprising the cellulose fibers in contact with an aqueous solution comprising N-methylmorpholine N-oxide (NMMO),
a step S4-22 of evaporating a portion of the water contained in the aqueous solution comprising NMMO and cellulose, in order to dissolve the cellulose and obtain a cellulose dope.

Step S4-21 allows dispersing the cellulose fibers by placing them in contact with an aqueous solution comprising NMMO in order to obtain a solution comprising water, NMMO, and cellulose, as well as the impurities, and to facilitate the next reaction.

The mass percentage of NMMO will preferably be chosen so as to be close to the zone of possible dissolution of cellulose in NMMO. The mass percentage of NMMO in the aqueous solution is preferably between 60 and 90%, preferably between 70 and 80%, more particularly 76%.

Step S4-22 allows evaporating the water from the aqueous solution comprising NMMO and thus dissolving the cellulose. After the water evaporates, a cellulose dope is obtained comprising dissolved and undissolved impurities as mentioned above.

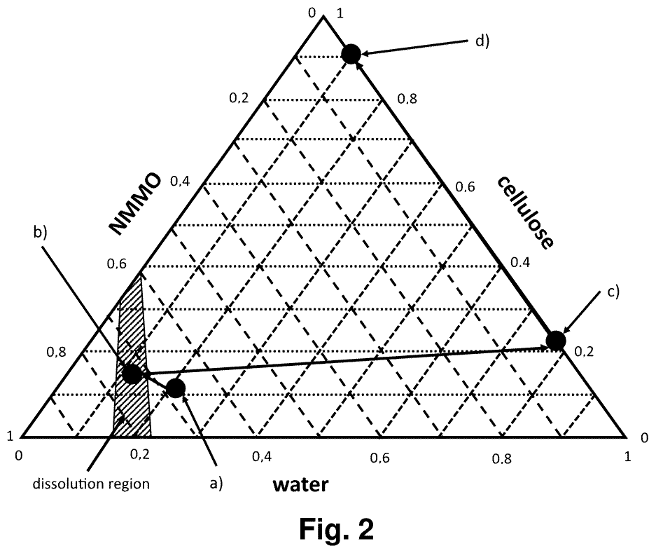

FIG. 2 shows a ternary diagram in which the axes respectively represent the mass percentage of water, the mass percentage of cellulose, and the mass percentage of NMMO, as well as the evolution in these proportions during implementation of the lyocell process.

The hatched area represents the region of cellulose dissolution in NMMO. Point a) represents the mixture comprising cellulose fibers and water before dissolution. By reducing the amount of water, the mixture moves towards point b) contained within the dissolution region in order to dissolve the cellulose. During dissolution of the cellulose, the amount of NMMO decreases until reaching point c) where the NMMO has completely reacted with the cellulose. The mixture at point c) thus comprises water and cellulose. Evaporation step S4-22 evaporates the water in order to concentrate the cellulose until reaching point d).

The pulp has a different viscosity depending on which step S4 is carried out. When it is obtained at the end of step S4-22, it has a much greater viscosity than at the end of step S4-17.

### Filtration Step S5

According to the invention, step S5 comprises filtration of the cellulose dope in order to obtain a cellulose dope that is separated from the undissolved particles.

Filtration step S5 allows filtering the cellulose dope obtained at the end of dissolution step S4 in order to recover a cellulose dope comprising cellulose in the form of pulp and dissolved impurities. The undissolved impurities are thus separated from the cellulose dope, making it possible to obtain a better quality of cellulose dope. The cellulose dope obtained at the end of step S5 still contains trace amounts of dissolved impurities.

Step S5 may in particular be carried out by means of a filter which the cellulose dope is passed through. The filter may comprise pores of a size between 5 and 100 μm, in particular between 5 and 54 μm, preferably between 10 and 50 μm, more particularly 19 μm, or, in certain cases, 6 μm. Such a pore size corresponds, in mesh size, to a mesh size of between 150 and 3000 mesh, in particular between 270 and 3000 mesh, preferably between 300 and 1500, more particularly 789 mesh, or, in certain cases, 2500 mesh.

Preferably, this filter is a metal filter, in particular formed of woven metal wires, and the pores have a square geometry. The size of the pores thus corresponds to a side of the square-shaped pore. Such fineness of the filter pores advantageously makes it possible to eliminate almost all of the undissolved impurities from the cellulose dope. Advantageously, the cellulose dope obtained is of better quality.

When the cellulose dope is obtained at the end of step S4-22, it has a higher viscosity. It may be helpful to heat the cellulose dope and apply pressure to help the cellulose dope pass through the filter.

Preferably, the cellulose dope obtained at the end of step S5 has a viscosity greater than 2 Pa·s.

When the cellulose dope is obtained according to the viscose process, the viscosity may be measured according to the ISO 12058-1:2018 standard, using a steel ball with a diameter of 14 mm, a stopwatch, and taking place at a temperature of 20° C.

When the cellulose dope is obtained according to the lyocell process, the viscosity may be measured according to the ISO 6721-10:2015 standard by means of oscillatory rheometry using parallel-plate geometry with plates having a diameter of 25 mm, with a plate separation of 1 mm, taking place at 90° C. and choosing a traction of 0.5%.

When the cellulose dope obtained at the end of step S5 has been previously dissolved according to the viscose process, the method for preparing cellulose dope may further comprise a spinning step S6, the spinning step being carried out by wet spinning.

According to one embodiment, when the cellulose dope obtained at the end of step S5 has been previously dissolved according to the lyocell process, the method for preparing cellulose dope may further comprise a spinning step S6, the spinning step being carried out by dry-jet wet spinning.

Spinning is a conventional technique for forming polymer filaments. This technique is known to those skilled in the art, as are its two variants, wet spinning and dry-jet wet spinning.

Spinning consists of extruding the polymer solution, also called spin dope. Extrusion is carried out through capillaries of a die. When the melting temperature of the polymer is higher than its degradation temperature, the polymer must undergo a technique of spinning in solution, also called wet spinning, to allow the formation of fibers. In the case where the technique used is wet spinning, the polymer solution is directly extruded into a coagulation bath, while in the case of dry-jet wet spinning the polymer solution is extruded into an evaporation chamber before being immersed in the coagulation bath.

It is also possible to recreate fibers by using cellulose dope prepared according to the method of this invention in another manner, in particular by coating.

### EXAMPLES

### Example 1a: Preparation of Cellulose Dope With a Dissolution Step According to the Viscose Process

Shredding step S1: 20 g of textile waste comprising a mass percentage of cellulose fiber of 60% are placed in a knife shredder. The textile waste is shredded so as to recover a first mixture of shredded fibers and residues having a size of less than 2 cm.

Separation step S2: 20 g of the mixture of shredded fibers and residues are introduced into 2 kg of aqueous solution comprising 8% by mass of sodium hydroxide and 1.61% by mass of BTBAC previously heated to 90° C. The solution is held at 90° C. for 1.5 h and stirred at 100 rpm.

Filtration step S3: the solution is filtered to recover the solid phase comprising the cellulose fibers. The solid phase is washed in a bath of 2% by weight acetic acid for 10 min. The solution is then filtered to recover the solid phase comprising the cellulose fibers. The solid phase is washed in a bath of distilled water for 10 min. The solution is filtered to recover the solid phase comprising the cellulose fibers, then dried in an oven at 105° C.

### Dissolution Step S4

Step S4-11: 3 g of solid phase comprising the cellulose fibers are introduced into 100 g aqueous solution comprising a mass percentage of 18% sodium hydroxide previously heated to 40° C. The solution is maintained at 40° C. for 40 min while stirring the solution at 100 rpm.

Step S4-12: The solution is pressed to remove the excess sodium hydroxide, until 9 g of alkaline cellulose fibers are recovered.

Step S4-13: The alkaline cellulose fibers are ground.

Step S4-14: They are then left to age at 50° C. in the presence of oxygen for 3 h40 min.

Step S4-15: The alkaline cellulose fibers are placed in a closed reactor under a hood at 32° C. 3 g of carbon disulfide are introduced into the reactor. The reactor is placed under vacuum and left for 2.5 h in order to form cellulose xanthate fibers.

Step S4-16: 18 g of an aqueous solution comprising 8% by mass of sodium hydroxide are introduced into the reactor. The reactor is left for 10 min. The contents of the reactor are stirred for 3 h at 5° C. in order to dissolve the cellulose xanthate fibers.

Step S4-17: The cellulose dope is then extracted from the reactor and placed under a hood for 16 hours at room temperature in a container covered with a perforated film.

Filtration step S5: the cellulose dope is placed in a device enabling pressure filtration. The filter pores are square in shape with a side measuring 19 μm. A pressure of 5 bar is then applied in order to pass the cellulose dope through the filter.

### Example 1b: Preparing a Cellulose Dope With a Dissolution Step According to the Viscose Process

The protocol implemented in Example 1a is implemented in Example 1b with the following modifications:

During separation step S2: the aqueous solution is 400 g and not 2 kg, and the solution is maintained at 90° C. for 40 min and not 1.5 h.

During step S4-14: the ground alkaline cellulose fibers are left to age at 30° C., not 50° C., in the presence of oxygen for 15 h30 min and not 3 h40 min.

During filtration step S5: the pores of the filter have a side measuring 6 μm.

### Example 2: Preparing a Cellulose Dope With a Dissolution Step According to the Lyocell Process

Based on the method described in Example 1b, it is possible to modify step S4 of dissolving the cellulose fibers.

Shredding step S1: as in Example 1.

Separation step S2: as in Example 1.

Filtration step S3: as in Example 1.

Shredding step S1′: The solid phase containing the cellulose fibers is shredded using a knife shredder to obtain a solid phase comprising the cellulose fibers, their size being less than 1 mm.

### Dissolution Step S4

Step S4-21: 116 g of aqueous solution comprising a mass percentage of 50% NMMO is placed in a florentine flask of a rotary evaporator. The water is evaporated under vacuum at 99° C. to remove 39 g of water. 10 g of the solid phase comprising the cellulose fibers are introduced into the florentine flask with 0.26 g of propyl gallate.

Step S4-22: The contents of the florentine flask are evaporated under vacuum using the rotary evaporator so as to eliminate 15 g of water.

Filtration step S5: the cellulose dope is placed in a device enabling pressure filtration, the cellulose dope having previously been heated to 110° C. The filter pores are square in shape with a side measuring 19 μm. A pressure of 15 bar is then applied in order to pass the cellulose dope through the filter.

### LIST OF REFERENCE NUMBERS

S0: smoothing step,
S1: shredding step,
S1′: shredding step,
S2: separation step,
S2′: decolorization step,
S3: filtration step,
S4: dissolution step,
S4-11: step of placing in contact with an alkaline aqueous solution,
S4-12: step of pressing the alkaline cellulose
S4-13: step of grinding the alkaline cellulose
S4-14: step of aging the alkaline cellulose
S4-15: step of placing in contact with carbon disulfide
S4-16: step of placing in contact with an alkaline aqueous solution
S4-17: step of maturing the cellulose dope
S4-21: step of placing in contact with an aqueous solution of NMMO
S4-22: evaporation step
S5: filtration step, and
S6: spinning step.

1-12. (canceled)

13. A method for preparing cellulose dope from textile waste comprising cellulose fibers in a mass percentage greater than 50%, the method comprising the following steps:
step (S1) shredding the textile waste in order to obtain a first mixture of shredded fibers and residues,
step (S2) separating at least a portion of the non-cellulosic components from the first mixture in order to obtain a second mixture in which the mass percentage of cellulose fibers is greater than the mass percentage of cellulose fibers in the first mixture,
step (S3) filtering the second mixture in order to recover a solid phase comprising the cellulose fibers,
step (S4) dissolving the cellulose fibers of the solid phase so as to obtain a cellulose dope comprising undissolved particles, and
step (S5) filtering the cellulose dope in order to obtain a cellulose dope that is separated from the undissolved particles.

14. The method for preparing cellulose dope according to claim 13, wherein step (S4) comprises:
a step (S4-11) of placing the solid phase comprising the cellulose fibers in contact with an alkaline aqueous solution comprising sodium hydroxide in order to obtain a solid phase of alkaline cellulose fibers,
a step (S4-12) of pressing the solid phase of alkaline cellulose fibers in order to eliminate the excess alkaline solution and obtain a compact solid phase of alkaline cellulose fibers,
a step (S4-13) of grinding the solid phase of alkaline cellulose fibers obtained at the end of step (S4-12), in order to obtain a solid phase of alkaline cellulose fibers that is less compact than the solid phase obtained at the end of step (S4-12),
a step (S4-14) of aging the solid phase comprising the alkaline cellulose fibers obtained at the end of step (S4-13),
a step (S4-15) of placing the solid phase of aged alkaline cellulose fibers in contact with carbon disulfide in order to obtain a solid phase of cellulose xanthate fibers,
a step (S4-16) of placing the solid phase of cellulose xanthate fibers in contact with an alkaline aqueous solution comprising sodium hydroxide in order to obtain a cellulose dope comprising undissolved particles, and
a step (S4-17) of maturing the cellulose dope comprising undissolved particles.

15. The method for preparing cellulose dope according to claim 13, wherein step (S4) comprises:
a step (S4-21) of placing the solid phase comprising the cellulose fibers in contact with an aqueous solution comprising N-methylmorpholine N-oxide (NMMO), and
a step (S4-22) of evaporating the water contained in the aqueous solution comprising (NMMO) and the solid phase comprising the cellulose fibers.

16. The method for preparing cellulose dope according to claim 13, wherein the textile waste comprises cellulose fibers in a mass percentage of less than 85%.

17. The method for preparing cellulose dope according to claim 13, wherein step (S2) is carried out by dissolving a portion of the non-cellulosic components of the first mixture by placing the first mixture in contact with an alkaline aqueous solution.

18. The method for preparing cellulose dope according to claim 17, wherein the aqueous alkaline solution is an aqueous alkaline solution based on sodium hydroxide, the mass percentage of the sodium hydroxide being between 3 and 25%.

19. The method for preparing cellulose dope according to claim 17, wherein step (S2) is carried out at a temperature between 50 and 150° C.

20. The method for preparing cellulose dope according to claim 17, wherein step (S2) is carried out during a time interval of between 15 and 240 minutes.

21. The method for preparing cellulose dope according to claim 17, wherein the alkaline aqueous solution comprises a phase transfer catalyst, the phase transfer catalyst being a quaternary ammonium.

22. The method for preparing cellulose dope according to claim 21, wherein the quaternary ammonium is benzyltributylammonium chloride, methyltrioctylammonium bromide, or mixtures thereof.

23. The method for preparing cellulose dope according to claim 22, wherein the quaternary ammonium is benzyltributylammonium chloride and the mass percentage of benzyltributylammonium chloride is between 0.1 and 2%.

24. The method for preparing cellulose dope according to claim 13, wherein step (S5) is carried out by means of a filter comprising pores of a size between 5 and 100 μm.
